(19) United States
(12) Patent Application Publication
(10) Pub. No.: US 2026/0227517 A1
(43) Pub. Date: Aug. 6, 2026

(54) Feedforward Localization

(71) Applicant: Nissan North America, Inc., Franklin, TN (US)

(72) Inventors: Pratham Oza, San Jose, CA (US); Shreyas Jha, Sunnyvale, CA (US); Liam Pedersen, San Francisco, CA (US); Jash Shah, Sunnyvale, CA (US); Dhanesh R. Pamnani, Sunnyvale, CA (US); Atharv Pulapaka, Sunnyvale, CA (US)

(21) Appl. No.: 19/044,389

(22) Filed: Feb. 3, 2025

(51) Int. Cl. G01S 17/931; G01S 17/08; G07C 5/02

(52) U.S. Cl. CPC G01S 17/931; B60W 60/001; G01S 17/08; G08G 1/0116; B60W 2420/408; B60W 2556/45

(57) ABSTRACT

A vehicle localization technique obtains odometry data associated with a vehicle and obtains a first estimated pose of the vehicle based on a sensor measurement associated with a stationary sensor external to the vehicle. A feedforward pose estimator determines a second estimated pose of the vehicle, wherein the feedforward pose estimator estimates the second estimated pose of the vehicle based on the odometry data and the first estimated pose of the vehicle. Based on the second estimated pose, localization data is output to cause a controller of the vehicle to perform an action based on the localization data.

### TECHNICAL FIELD

This application relates to controlling vehicles in a controlled roadway environment, and more particularly relates to feedforward localization.

### BACKGROUND

Autonomous vehicle systems have gained attention in recent years as a promising solution for improving transportation safety and efficiency. These systems rely on various sensors and algorithms to perceive the environment, make decisions, and control vehicle movements. However, accurate localization of autonomous vehicles remains a challenge, particularly in environments with limited or unreliable GPS coverage. Traditional localization methods may struggle to provide precise and timely position estimates, especially when dealing with sensor data from multiple sources that may have different update rates and latencies. As autonomous vehicle technology continues to advance, there is a need for robust localization techniques that can effectively integrate data from both on-board vehicle sensors and external infrastructure to ensure safe and reliable operation across diverse driving scenarios.

### SUMMARY

In one embodiment, a system for vehicle localization is provided. In this embodiment, the system includes one or more memories storing computer-executable instructions and processing circuitry communicatively coupled to the one or more memories. The processing circuitry is configured to execute the computer-executable instructions to cause the system to obtain odometry data associated with a vehicle, obtain a first estimated pose of the vehicle based on a sensor measurement associated with a stationary sensor external to the vehicle, determine, via a feedforward pose estimator, a second estimated pose of the vehicle, wherein the feedforward pose estimator is configured to estimate the second estimated pose of the vehicle based on the odometry data and the first estimated pose of the vehicle, and output, based on the second estimated pose, localization data to cause a controller of the vehicle to perform an action based on the localization data.

In another embodiment, a method for vehicle localization is provided. In this embodiment, the method includes obtaining odometry data associated with a vehicle, obtaining a first estimated pose of the vehicle based on a sensor measurement associated with a stationary sensor external to the vehicle, determining, via a feedforward pose estimator, a second estimated pose of the vehicle, wherein the feedforward pose estimator is configured to estimate the second estimated pose of the vehicle based on the odometry data and the first estimated pose of the vehicle, and outputting, based on the second estimated pose, localization data to cause a controller of the vehicle to perform an action based on the localization data.

In yet another embodiment, a non-transitory computer-readable storage medium storing a set of instructions is provided. In this embodiment, when executed by processing circuitry of a controller of a vehicle, the instructions cause the controller to perform operations comprising obtaining odometry data associated with a vehicle, obtaining a first estimated pose of the vehicle based on a sensor measurement associated with a stationary sensor external to the vehicle, determining, via a feedforward pose estimator, a second estimated pose of the vehicle, wherein the feedforward pose estimator is configured to estimate the second estimated pose of the vehicle based on the odometry data and the first estimated pose of the vehicle, and outputting, based on the second estimated pose, localization data to cause a controller of the vehicle to perform an action based on the localization data.

These and other aspects, features, elements, implementations, and embodiments of the methods, apparatus, procedures, and algorithms disclosed herein are described in further detail hereafter.

### BRIEF DESCRIPTION OF THE DRAWINGS

The disclosed technology is best understood from the following detailed description when read in conjunction with the accompanying drawings. It is emphasized that, according to common practice, the various features of the drawings may not be to scale. For example, the dimensions of various features may be expanded or reduced for clarity. Further, like reference numbers refer to like elements throughout the drawings unless otherwise noted.

FIG. 1 is a diagram of an example of a vehicle in which the aspects, features, and elements disclosed herein may be implemented.

FIG. 2 is a diagram of an example of a portion of a vehicle transportation and communication system in which the aspects, features, and elements disclosed herein may be implemented.

FIG. 3 shows a block diagram of an example of a computing device capable of performing functions described later herein.

FIG. 4 illustrates an example of a controlled roadway region, in accordance with the present disclosure.

FIG. 5 is a flow diagram illustrating an example of a process for controlling a vehicle in a controlled roadway region, in accordance with the present disclosure.

FIG. 6 is a diagram illustrating an example of a vehicle having an in-vehicle controller, in accordance with embodiments of this disclosure.

FIG. 7 is a diagram illustrating an example of a vehicle logistics system, in accordance with the present disclosure.

FIG. 8 is a diagram illustrating an example associated with feedforward localization, in accordance with the present disclosure.

FIG. 9 is a schematic block diagram illustrating an example of a process for feedforward localization, in accordance with the present disclosure.

FIG. 10 is a flow diagram illustrating an example of a technique for feedforward localization, in accordance with the present disclosure.

### DETAILED DESCRIPTION

A transportation network may incorporate infrastructure sensors, such as light detection and ranging (LiDAR) sensors, strategically placed along roadways, intersections, and/or high-traffic areas. These infrastructure sensors can be configured to collect environmental data, such as positions, speeds, directions of travel, and/or orientations of objects such as vehicles and surrounding obstacles within the sensors' respective fields of view. Such data can be communicated to a cloud-based system, where it can be processed and analyzed to generate insights or instructions relevant to the operation of connected vehicles. For example, the cloud-based system can determine optimal driving patterns, provide control instructions to vehicles, alert vehicles to potential hazards, and/or regulate traffic flow based on real-time conditions gathered by the infrastructure sensors.

In some cases, the connected vehicles may be fully autonomous vehicles. In other cases, the connected vehicles in such examples may not be fully autonomous but may be equipped with communication modules that enable bidirectional communication with the cloud-based system. A connected vehicle may receive driving control instructions, recommendations regarding lane changes, speed adjustments, and/or route modifications based on data captured by LiDAR sensors within the transportation network. Examples of scenarios in which such infrastructure sensors and control systems may be implemented may include controlled roadway regions. The term “controlled roadway region” may include a defined area within which at least a portion of (and, in some cases, a majority of) the traffic on the roadways therein is subject to control by a single entity (e.g., a human operator, a company, a conglomerate of companies, a governmental entity, etc.). One example of a controlled roadway region is an area in which finished vehicles are managed and transported, such as a factory property, test course, or distribution center, among other examples. Another example of a controlled roadway region is a construction zone in which construction vehicles may be controlled via external systems. Yet another example of a controlled roadway region is an airport in which various vehicles such as refueling vehicles, baggage carriers, and/or other vehicles may be controlled via an airport system. In some examples, a controlled roadway region can include any portion of a highway, town, and/or other area in which infrastructure sensors have been installed to support external control of at least one vehicle on the roadways therein.

In the field of autonomous vehicle control, precise localization may be important for safe and efficient operation. Traditional localization methods often rely on onboard sensors such as geolocation sensors (e.g., global positioning system (GPS) devices), cameras, and LiDAR to determine a vehicle's position and orientation. However, these systems may face challenges when operating in environments with limited GPS coverage or in scenarios where real-time, high-precision localization is required. The increasing complexity of autonomous driving scenarios, particularly in controlled roadway regions such as factory campuses or distribution centers, may necessitate more robust and accurate localization techniques.

A technical challenge in current autonomous vehicle systems may be the integration of data from multiple sources, each with different update rates and latencies. For instance, infrastructure-based sensors like stationary LiDAR units can provide highly accurate position measurements, but these measurements may be delayed due to processing time and communication latency. Meanwhile, onboard odometry sensors offer real-time data about the vehicle's movement, but are prone to accumulating errors over time. The discrepancy in timing and accuracy between these data sources may create a hurdle in achieving reliable, up-to-date localization estimates.

Furthermore, the computational demands of processing and fusing data from multiple sensors in real-time may pose a challenge. Many existing systems may struggle to efficiently combine delayed external measurements with more recent onboard sensor data, leading to potential inaccuracies in the vehicle's estimated position and orientation. This problem may be exacerbated in scenarios where the vehicle is moving at high speeds or performing complex maneuvers, as even small errors in localization can result in deviations from the intended path.

Another issue may be the system's ability to maintain accurate localization in the presence of communication delays or temporary sensor outages. In controlled roadway environments, where vehicles may need to navigate through areas with varying levels of sensor coverage or network connectivity, maintaining a consistent and accurate estimate of the vehicle's pose may become challenging. The inability to robustly handle these variations in data availability and quality can lead to degraded performance or safety risks in autonomous vehicle operations.

Implementations of this disclosure address problems such as these by providing a system and method for vehicle localization that combines delayed external sensor measurements with real-time on-board odometry data to generate accurate and up-to-date vehicle pose estimates. The system includes a feedforward pose estimator that processes odometry data associated with a vehicle and a first estimated pose of the vehicle based on a sensor measurement from a stationary sensor external to the vehicle to determine a second estimated pose of the vehicle. This second estimated pose is then used to output localization data that causes a controller of the vehicle to perform an action.

The term “odometry data” as used herein refers to information about the vehicle's movement, including but not limited to the vehicle's speed and steering angle. For example, odometry data may include wheel encoder readings, inertial measurement unit (EIU) data, or steering angle sensor measurements. In some implementations, the odometry data may also include data from visual odometry systems that estimate movement based on camera images.

The “first estimated pose” of the vehicle refers to sensor measurements obtained by a stationary sensor external to the vehicle and/or to information derived from the sensor measurements. As used in this disclosure, a “stationary sensor” refers to a fixed sensor infrastructure element, such as a LiDAR sensor, a radar system, or a camera array mounted on roadside structures. These sensors provide measurements that may include, but are not limited to, range, bearing, or visual information about the vehicle's position relative to known reference points in the environment, among other examples. For example, stationary sensors such as LiDAR sensors may provide at least a set of three-dimensional (3D) points, which may be used to derive measurements such as relative distance or pose once the vehicle whose position is being estimated is identified from the collection of 3D points. “First estimated pose” may refer to the 3D points or the derived measurements (e.g., relative distance, pose, etc.).

The feedforward pose estimator employs a feedforward estimation model to combine the odometry data and the first estimated pose. In some implementations, this model is based on a Kalman filter such as, for example, an extended Kalman filter (EKF) or an unscented Kalman filter (UKF). The Kalman filter provides a framework for fusing measurements from different sources while accounting for their respective uncertainties. The EKF may be further enhanced by incorporating a kinematic bicycle model (KBM), which provides a simplified representation of the vehicle's motion dynamics. In some implementations, other filtering techniques such as particle filters or more complex vehicle dynamics models may be used. In some implementations, the feedforward pose estimator may perform a localization algorithm, a state estimation algorithm, a sensor fusion algorithm, or a combination thereof. The above algorithms may be performed, for example, using an EKF, a UKF, a maximum likelihood estimation (MLE), or an optimization-based algorithm, among other examples.

To manage the flow of data from different sources with varying update rates and latencies, the system utilizes a buffering mechanism. The buffering mechanism may include one buffer or multiple buffers. In the case of multiple buffers, a first buffer may store a plurality of measurements including the first estimated pose of the vehicle, while a second buffer may store measurements including the odometry data. These buffers may be implemented as linear buffers or ring buffers, allowing for efficient storage and retrieval of time-sequenced data.

Maintaining a single buffer may be advantageous for separating computing threads. For example, the EKF algorithm may assume that the sensor measurements coming in (or odometry/KBM data, first estimated pose from external sensors, GPS etc.) are sorted by timestamp. Maintaining a single buffer enables this sorting to be performed on a separate compute thread from the computing thread on which the EKF algorithm is running. If separate buffers are used, determining the order of measurements to send to the EKF (sorting measurements from different sources) may entail a computation task that would have to happen in the same thread on which the EKF computation occurs. In some implementation, the use of separate buffers for different data types may enable the system to handle asynchronous updates and compensate for communication delays between the external sensors and the vehicle.

In various embodiments, the disclosed system may implement a localization, state estimation, or sensor fusion algorithm, such as an EKF, UKF, MLE, or an optimization-based approach. The algorithm may operate with a time delay, such as approximately 200 milliseconds prior to the current time or the most recent sensor source, to accommodate delayed sensor measurements. These delayed measurements may arise from various sources, including an external sensor providing initial pose or range measurements via a communications setup in a VLA system or an onboard deep-learning module that requires processing time to generate sensory information for use by the localization, state estimation, or sensor fusion algorithm.

Despite the core algorithm operating at a delay, a most recent estimate of the vehicle's state, including but not limited to position, orientation, and velocity, may be obtained by incorporating odometry data. The odometry data may be derived from various sources, such as a kinematic bicycle model (KBM) utilizing Controller Area Network (CAN) data or a visual odometry model utilizing camera-based data.

To facilitate the implementation of the disclosed solution, certain supporting tools and methodologies may be employed. For instance, a feedforward approach may be utilized to efficiently integrate odometry data with the delayed estimate generated by the EKF or other core algorithm operating at a delay. Additionally, a buffering mechanism may be implemented to store measurements from different sensor sources, enabling their retrieval and use as needed within the core algorithm. The sensor measurements from different sources are time-synchronized, ensuring consistency in the estimation process.

The technical solution presented in this disclosure may improve upon traditional localization methods by addressing the challenges of integrating delayed external measurements with real-time on-board data. By employing a feedforward estimation approach, the system can predict and update the vehicle's pose more accurately than systems relying solely on GPS or on-board sensors. This enhanced localization capability enables more precise and reliable autonomous vehicle control, particularly in environments with limited GPS coverage or in scenarios requiring high-precision navigation, such as automated parking or coordinated fleet movements in controlled roadway regions.

In some implementations, the system utilizes a feedforward pose estimator to determine a second estimated pose of the vehicle based on odometry data and a first estimated pose. Accordingly, an advantage of the feedforward pose estimator may be improved localization accuracy by combining real-time vehicle data with external sensor measurements. Additionally, an advantage of the feedforward pose estimator may be reduced latency in pose estimation, as it can predict the current vehicle position even when external sensor data is delayed. In some implementations, an advantage of the feedforward pose estimator may be the enablement of slower processing (e.g., associated with deep learning) on board the vehicle. Furthermore, an advantage of the feedforward pose estimator may be increased robustness to sensor failures or communication interruptions, as it can continue to provide pose estimates based on odometry data alone for short periods.

In some implementations, the system employs an extended Kalman filter as part of the feedforward estimation model. Accordingly, an advantage of the extended Kalman filter may be its ability to handle non-linear systems, making it well-suited for vehicle dynamics modeling. Additionally, an advantage of the extended Kalman filter may be its computational efficiency, allowing for real-time processing of sensor data and pose estimation. Moreover, an advantage of the extended Kalman filter may be its ability to provide uncertainty estimates along with pose predictions, enabling more informed decision-making in the vehicle control system.

In some implementations, the system utilizes separate buffers for storing odometry data and external sensor measurements. Accordingly, an advantage of the separate buffer system may be improved data management, allowing for efficient handling of asynchronous sensor inputs. Additionally, an advantage of the separate buffer system may be enhanced flexibility in processing different data types, as each buffer can be optimized for its specific data characteristics. Furthermore, an advantage of the separate buffer system may be increased fault tolerance, as issues with one data stream are less likely to affect the processing of the other.

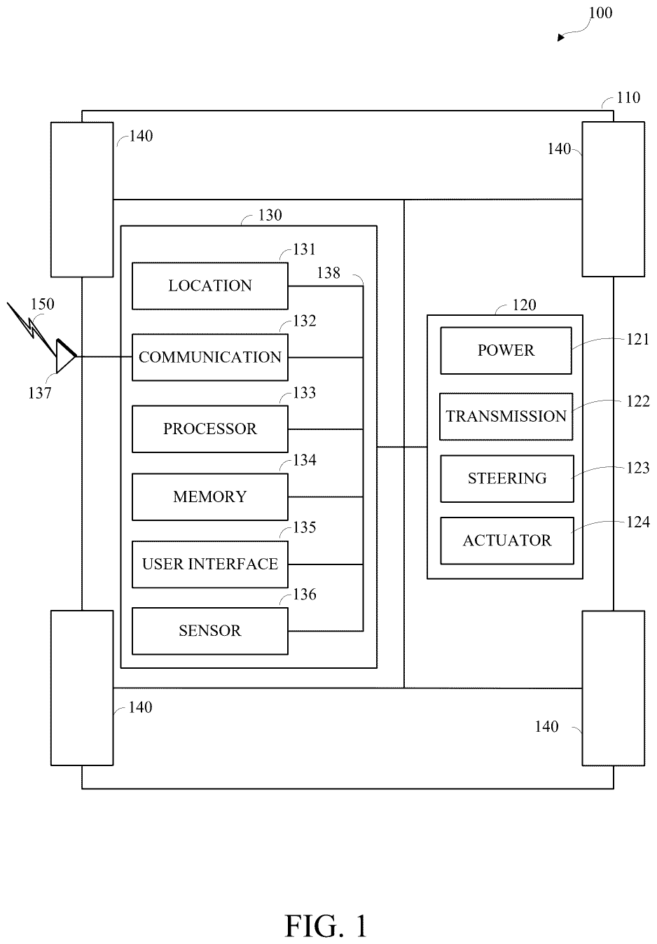

In controlled roadway environments, implementations may include a vehicle logistics autonomy (VLA) system located outside of a vehicle and configured to determine driving operations for controlling the vehicle. The VLA system may generate driving instructions for controlling the vehicle to traverse a transportation network of a controlled roadway region. The VLA system may transmit those instructions to an in-vehicle control unit (ICU) implemented in the vehicle. The ICU may be temporarily installed in the vehicle and may include at least one sensor. In some implementations, the ICU may be permanently installed in the vehicle (e.g., in the case of a fully autonomous vehicle). The VLA system may transmit a control signal to the ICU, where the control signal is indicative of the driving instructions or information from which driving instructions may be derived by the ICU. Throughout this disclosure, an “ICU” may refer to a separate in-vehicle control unit, as described above and/or a portion of an electronic control unit (ECU) (e.g., the controller 130 shown in FIG. 1) of the vehicle.

Implementations of this disclosure may enable the ICU to receive additional instructions from a tele-operation device to control the vehicle. This capability allows for human intervention when necessary, providing a flexible system that can adapt to unexpected situations or complex scenarios that may arise. The VLA system may also determine an occurrence of an operation issue with the vehicle and communicate an indication of the operation issue to the tele-operation device, facilitating rapid response to potential problems and maintaining efficient operations within the controlled roadway region.

The term “controlled roadway region” may include a defined area within which a majority of the traffic on the roadways therein is subject to control by a single entity (e.g., a human operator, a company, a conglomerate of companies, a governmental entity, etc.). One example of a controlled roadway region is an area in which finished vehicles are managed and transported, such as a factory property, test course, or distribution center, among other examples. Another example of a controlled roadway region may include an airport, in which vehicles may be used to facilitate providing services to aircraft, maintenance, and/or the like. Controlled roadway regions may be implemented in any number of different scenarios, all of which are considered to be within the ambit of the present disclosure.

A controlled roadway region, as defined in this disclosure, can differ significantly from a typical roadway region in a number of aspects. In a controlled roadway region, a single entity may have authority over at least some of the traffic, allowing for a more structured and predictable environment. This level of control can enable the implementation of specialized systems and protocols that may not be feasible in typical roadway regions where traffic is more diverse and less regulated.

One of the primary differences between a controlled roadway region and a typical roadway region is the ability to implement comprehensive sensor networks and infrastructure components throughout the controlled roadway region. These systems may include cameras, LiDAR sensors, and/or other monitoring devices that provide data about vehicle positions, speeds, orientations, and/or environmental conditions. In contrast, typical roadway regions may have limited sensor coverage, relying more heavily on individual vehicle sensors and sporadic traffic monitoring systems.

The controlled nature of the roadway region also may allow for the implementation of standardized communication protocols between connected vehicles and infrastructure. This may include dedicated short-range communication (DSRC) systems or cellular vehicle-to-everything (C-V2X) technologies that enable seamless information exchange. Such comprehensive communication networks are often not feasible in typical roadway regions due to the diverse range of vehicles and the challenges of retrofitting existing infrastructure.

Implementations of the VLA system described herein take advantage of these differences by utilizing the controlled environment to create a more efficient and predictable system for managing vehicles. The VLA system can leverage the comprehensive sensor data and communication networks to maintain an accurate and up-to-date world model of the entire controlled roadway region. This allows for more precise planning and coordination of vehicle movements, reducing the likelihood of conflicts or inefficiencies that might occur in less controlled environments.

Furthermore, short, established routes that vehicles may take within a controlled roadway region can present unique opportunities for optimization. Unlike typical automated vehicles that may need to navigate complex and unpredictable city streets or highways, vehicles in a controlled roadway region may follow predetermined paths between known points of interest, such as assembly lines, testing areas, and distribution centers. This may allow the VLA system to create highly optimized trajectories and schedules, taking into account factors such as production timing, vehicle specifications, and distribution requirements.

In some implementations, the controlled environment may enable the use of removable ICUs in vehicles. These ICUs can be designed specifically for the controlled roadway region, focusing on the limited set of maneuvers and routes required within the facility. This contrasts with the more complex autonomous driving systems needed for typical automated vehicles that must handle a wide range of driving scenarios and environments. The removable ICUs may be more cost-effective and easier to install and remove, facilitating the efficient movement of vehicles through logistics processes.

According to some implementations, a VLA system (which may be implemented as one or more physical machines and/or virtual machines) accesses infrastructure data from sensors of an infrastructure associated with a roadway portion of the controlled roadway region. The sensors may include any number of different types of roadway sensors. The infrastructure data may include a position of a vehicle, a velocity of a vehicle, and/or a following distance of another vehicle in relation to the vehicle, among other examples. The VLA system may store the infrastructure data in a world model. The VLA system may generate, using the world model, a data structure representing predicted future velocities on the roadway portion by position and time by applying a traffic flow model to the world model. The traffic flow model may be, for example, an artificial intelligence model trained using at least one of supervised learning, unsupervised learning, reinforcement learning, online learning, or the like.

The VLA system may transmit a control signal to the removable ICU provided in a vehicle for controlling operation of the vehicle based on the generated data structure. In some implementations, the ICU may be connected to a controller of the vehicle. The controller may include a computing device on board the vehicle. In an example, the control signal can be a specific control parameter (e.g., specific control parameter values) that may be used to control a component of the powertrain of the vehicle. In another example, the control signal can be or include data that the ICU can use to obtain the control parameter. For example, the ICU may be or include a machine leaning model that uses at least portions of the control signal to obtain (e.g., infer, output) the control parameter that can be used to control the component of the powertrain of the vehicle. The control parameter can depend on the capabilities of the ICU and/or of the vehicle.

As used herein, the term “model” may include, among other things, at least one of a classic planning model, an artificial intelligence (AI) model, or a machine-learning (ML) model that uses supervised learning, unsupervised learning, reinforcement learning, or the like. A model may be based on data that was generated in the past and may be used to predict future data. For example, a long-term shared world model of a roadway portion may store data about average velocities and congestion (e.g., number of vehicles per unit distance) of the roadway portion in the past (e.g., at multiple times in the past three years) and be used to predict the average velocities and the congestion of the roadway portion in the future (e.g., next Monday morning at 9 am). The prediction may be made, for example, using AI or ML techniques or other mathematical modeling techniques.

FIG. 1 is a diagram of an example of a vehicle in which the aspects, features, and elements disclosed herein may be implemented. As shown, a vehicle 100 includes a chassis 110, a powertrain 120, a controller 130, and wheels 140. Although the vehicle 100 is shown as including four wheels 140 for simplicity, any other propulsion device or devices, such as a propeller or tread, may be used. In FIG. 1, the lines interconnecting elements, such as the powertrain 120, the controller 130, and the wheels 140, indicate that information, such as data or control signals, power, such as electrical power or torque, or both information and power, may be communicated between the respective elements. For example, the controller 130 may receive power from the powertrain 120 and may communicate with the powertrain 120, the wheels 140, or both, to control the vehicle 100, which may include accelerating, decelerating, steering, or otherwise controlling the vehicle 100.

As shown, the powertrain 120 includes a power source 121, a transmission 122, a steering unit 123, and an actuator 124. Other elements or combinations of elements of a powertrain, such as a suspension, a drive shaft, axles, or an exhaust system may be included. Although shown separately, the wheels 140 may be included in the powertrain 120.

The power source 121 may include an engine, a battery, or a combination thereof. The power source 121 may be any device or combination of devices operative to provide energy, such as electrical energy, thermal energy, or kinetic energy. For example, the power source 121 may include an engine, such as an internal combustion engine, an electric motor, or a combination of an internal combustion engine and an electric motor, and may be operative to provide kinetic energy as a motive force to one or more of the wheels 140. The power source 121 may include a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 122 may receive energy, such as kinetic energy, from the power source 121, and may transmit the energy to the wheels 140 to provide a motive force. The transmission 122 may be controlled by the controller 130 the actuator 124 or both. The steering unit 123 may be controlled by the controller 130 the actuator 124 or both and may control the wheels 140 to steer the vehicle. The actuator 124 may receive signals from the controller 130 and may actuate or control the power source 121, the transmission 122, the steering unit 123, or any combination thereof to operate the vehicle 100.

As shown, the controller 130 may include a location unit 131, an electronic communication unit 132, a processor 133, a memory 134, a user interface 135, a sensor 136, an electronic communication interface 137, or any combination thereof. Although shown as a single unit, any one or more elements of the controller 130 may be integrated into any number of separate physical units. For example, the user interface 135 and the processor 133 may be integrated in a first physical unit and the memory 134 may be integrated in a second physical unit. Although not shown in FIG. 1, the controller 130 may include a power source, such as a battery. Although shown as separate elements, the location unit 131, the electronic communication unit 132, the processor 133, the memory 134, the user interface 135, the sensor 136, the electronic communication interface 137, or any combination thereof may be integrated in one or more electronic units, circuits, or chips.

The processor 133 may include any device or combination of devices capable of manipulating or processing a signal or other information now-existing or hereafter developed, including optical processors, quantum processors, molecular processors, or a combination thereof. For example, the processor 133 may include one or more special purpose processors, one or more digital signal processors, one or more microprocessors, one or more controllers, one or more microcontrollers, one or more integrated circuits, one or more Application Specific Integrated Circuits, one or more Field Programmable Gate Array, one or more programmable logic arrays, one or more programmable logic controllers, one or more state machines, one or more graphics processing units (GPUs), or any combination thereof. The processor 133 may be operatively coupled with the location unit 131, the memory 134, the electronic communication interface 137, the electronic communication unit 132, the user interface 135, the sensor 136, the powertrain 120, or any combination thereof. For example, the processor may be operatively coupled with the memory 134 via a communication bus 138.

The memory 134 may include any tangible non-transitory computer-usable or computer-readable medium, capable of, for example, containing, storing, communicating, or transporting machine readable instructions, or any information associated therewith, for use by or in connection with the processor 133. The memory 134 may be, for example, one or more solid state drives, one or more memory cards, one or more removable media, one or more read-only memories, one or more random access memories, one or more disks, including a hard disk, a floppy disk, an optical disk, a magnetic or optical card, or any type of non-transitory media suitable for storing electronic information, or any combination thereof.

The communication interface 137 may be a wireless antenna, as shown, a wired communication port, an optical communication port, or any other wired or wireless unit capable of interfacing with a wired or wireless electronic communication medium 150. Although FIG. 1 shows the communication interface 137 communicating via a single communication link, a communication interface may be configured to communicate via multiple communication links. The communication interface 137 may be in communication with a satellite. Although FIG. 1 shows a single communication interface 137, a vehicle may include any number of communication interfaces.

The communication unit 132 may be configured to transmit and/or receive signals via a wired or wireless electronic communication medium 150, such as via the communication interface 137. Although not explicitly shown in FIG. 1, the communication unit 132 may be configured to transmit, receive, or both via any wired or wireless communication medium, such as radio frequency (RF), ultraviolet (UV), visible light, fiber optic, wireline, satellite signals, or a combination thereof. For example, the communication unit 132 may be configured to transmit and/or receive telecommunication protocols such as 4G, 5G, Long Term Evolution (LTE), and/or 6G, among other examples. The communication unit 132 may be configured to communicate via sidelink networks using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols, among other examples. Although FIG. 1 shows a single communication unit 132 and a single communication interface 137, any number of communication units and any number of communication interfaces may be used. The communication unit 132 may include a dedicated short-range communications (DSRC) unit, an on-board unit (OBU), or a combination thereof.

The location unit 131 may determine geolocation information, such as longitude, latitude, elevation, direction of travel, or velocity, of the vehicle 100. For example, the location unit may include or be in communication with, a GPS unit (which may be referred to as a “GPS receiver” or a “GPS device”), a global navigation satellite system (GNSS), a Wide Area Augmentation System (WAAS) enabled National Marine-Electronics Association (NMEA) unit, a radio triangulation unit, or a combination thereof. The location unit 131 can be used to obtain information that represents, for example, a current heading of the vehicle 100, a current position of the vehicle 100 in two or three dimensions, a current angular orientation of the vehicle 100, or a combination thereof.

The user interface 135 may include any unit capable of interfacing with a person, such as a virtual or physical keypad, a touchpad, a display, a touch display, a heads-up display, a virtual display, an augmented reality display, a haptic display, a feature tracking device, such as an eye-tracking device, a speaker, a microphone, a video camera, a sensor, a printer, or any combination thereof. The user interface 135 may be operatively coupled with the processor 133, as shown, or with any other element of the controller 130. Although shown as a single unit, the user interface 135 may include one or more physical units. For example, the user interface 135 may include an audio interface for performing audio communication with a person and a touch display for performing visual and touch-based communication with the person. The user interface 135 may include multiple displays, such as multiple physically separate units, multiple defined portions within a single physical unit, or a combination thereof.

The sensor 136 may include one or more sensors, such as an array of sensors, which may be operable to provide information that may be used to control the vehicle. The sensors 136 may provide information regarding current operating characteristics of the vehicle 100. The sensor 136 can include, for example, a speed sensor, acceleration sensors, a steering angle sensor, traction-related sensors, braking-related sensors, steering wheel position sensors, eye tracking sensors, seating position sensors, a LiDAR sensor, a GPS device, a GNSS device, an IMU, cameras, or any sensor, or combination of sensors, operable to report information regarding some aspect of the current dynamic situation of the vehicle 100.

The sensor 136 may include one or more sensors operable to obtain information regarding the physical environment surrounding the vehicle 100. For example, one or more sensors may detect road geometry and features, such as lane lines, and obstacles, such as fixed obstacles, vehicles, and pedestrians. The sensor 136 can be or include one or more video cameras, laser-sensing systems, infrared-sensing systems, acoustic-sensing systems, or any other suitable type of on-vehicle environmental sensing device, or combination of devices, now known or later developed. In some embodiments, the sensors 136 and the location unit 131 may be a combined unit.

Although not shown separately, the vehicle 100 may include a trajectory follower. For example, the controller 130 may include the trajectory follower. The trajectory controller may be operable to obtain information describing a current state of the vehicle 100 and a route planned for the vehicle 100, and, based on this information, to determine and optimize a trajectory for the vehicle 100. In some embodiments, the trajectory follower may output signals operable to control the vehicle 100 such that the vehicle 100 follows the trajectory that is determined by the trajectory follower. In some embodiments, the trajectory follower may follow a trajectory that is determined by an external system (e.g., a VLA system). A trajectory may include an optimized trajectory that may be supplied to the powertrain 120, the wheels 140, or both. In some embodiments, the optimized trajectory can be control inputs such as a set of steering angles, with each steering angle corresponding to a point in time or a position. In some embodiments, the optimized trajectory can be one or more paths, lines, curves, or a combination thereof.

One or more of the wheels 140 may be a steered wheel, which may be pivoted to a steering angle under control of the steering unit 123, a propelled wheel, which may be torqued to propel the vehicle 100 under control of the transmission 122, or a steered and propelled wheel that may steer and propel the vehicle 100.

A vehicle may include units, or elements, not expressly shown in FIG. 1, such as an enclosure, a Bluetooth® module, a frequency modulated (FM) radio unit, a Near Field Communication (NFC) module, a liquid crystal display (LCD) display unit, an organic light-emitting diode (OLED) display unit, a speaker, or any combination thereof.

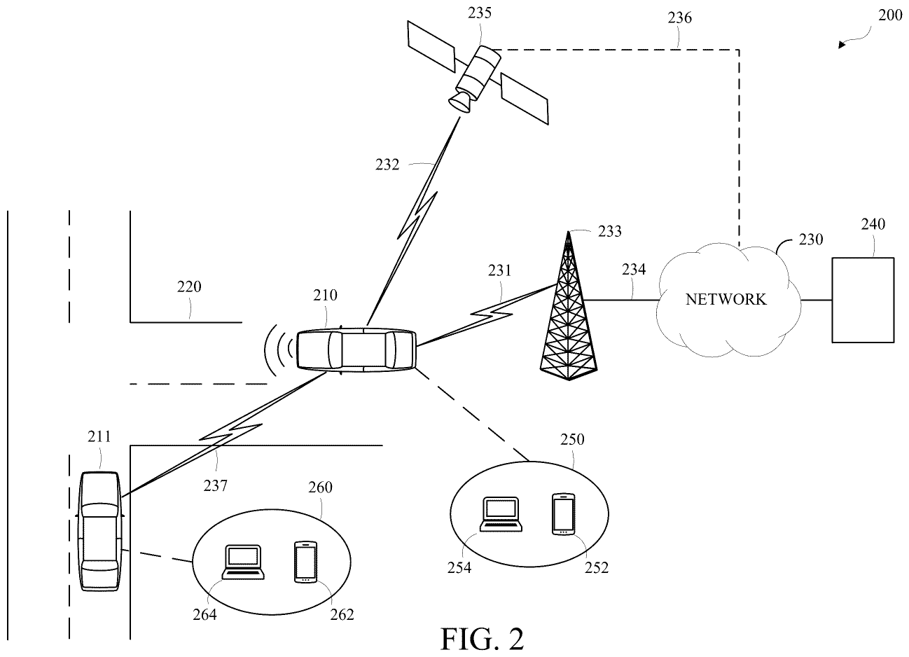

FIG. 2 is a diagram of an example of a portion of a vehicle transportation and communication system 200 in which the aspects, features, and elements disclosed herein may be implemented. The vehicle transportation and communication system 200 may include one or more vehicles 210/211, such as the vehicle 100 shown in FIG. 1, which may travel via one or more portions of one or more vehicle transportation networks 220, and may communicate via one or more electronic communication networks 230. Although not explicitly shown in FIG. 2, a vehicle may traverse an area that is not expressly or completely included in a vehicle transportation network, such as an off-road area.

The electronic communication network 230 may be, for example, a multiple access system and may provide for communication, such as voice communication, data communication, video communication, messaging communication, or a combination thereof, between the vehicle 210/211, one or more communication devices 240, and/or an operations center 242. For example, a vehicle 210/211 may receive information, such as information representing the vehicle transportation network 220, from a communication device 240 and/or the operations center 242 via the network 230.

The operations center 242 may include a controller apparatus 244, which may include some or all of the features of the controller 130 shown in FIG. 1. In some implementations, the operations center 242 and/or the controller apparatus 244 may be, be similar to, include, or be included in a VLA system. The controller apparatus 244 may be configured to monitor and coordinate the movement of vehicles, including connected vehicles and/or autonomous vehicles. The controller apparatus 244 may monitor the state or condition of vehicles, such as the vehicle 210, vehicle 211, and/or any number of external objects. The controller apparatus 244 may be configured to receive vehicle data and infrastructure data including vehicle velocity, vehicle location, vehicle orientation, vehicle operational state, vehicle destination, vehicle route, vehicle sensor data, external object velocity, external object location, external object orientation, external object operational state, external object destination, external object route, and/or external object sensor data, among other examples.

Further, the controller apparatus 244 may establish remote control over one or more vehicles, such as the vehicle 210, the vehicle 211, or external objects. In this way, the controller apparatus 244 may be used to teleoperate the vehicles or external objects from a remote location. The controller apparatus 244 may exchange (send or receive) state data with vehicles, external objects, and/or a computing device via a wireless communication link, such as the wireless communication link 231, or a wired communication link, such as the wired communication link 234. The operations center 242 and/or the controller apparatus 244 may include one or more server computing devices, which may exchange (send or receive) state signal data with one or more vehicles or computing devices).

In some embodiments, a vehicle 210/211 may communicate via a wired communication link (not shown), a wireless communication link 231/232/237, or a combination of any number of wired or wireless communication links. For example, as shown, a vehicle 210/211 may communicate via a terrestrial wireless communication link 231, via a non-terrestrial wireless communication link 232, or via a combination thereof. The terrestrial wireless communication link 231 may include an Ethernet link, a serial link, a Bluetooth link, an infrared (IR) link, a UV link, an RF link, or any link capable of providing for electronic communication.

A vehicle 210/211 may communicate with another vehicle 210/2110. For example, a host, or subject, vehicle (HV) 210 may receive one or more automated inter-vehicle messages, such as a basic safety message (BSM), from a remote, or target, vehicle (RV) 211, via a direct communication link 237, or via a network 230. For example, the remote vehicle 211 may broadcast the message to host vehicles within a defined broadcast range, such as 300 meters. In some embodiments, the host vehicle 210 may receive a message via a third party, such as a signal repeater (not shown) or another remote vehicle (not shown). A vehicle 210/211 may transmit one or more automated inter-vehicle messages periodically, based on, for example, a defined interval, such as 100 milliseconds.

Automated inter-vehicle messages may include vehicle identification information, geospatial state information, such as longitude, latitude, or elevation information, geospatial location accuracy information, kinematic state information, such as vehicle acceleration information, yaw rate information, velocity information, vehicle heading information, braking system status information, throttle information, steering wheel angle information, or vehicle routing information, or vehicle operating state information, such as vehicle size information, headlight state information, turn signal information, wiper status information, transmission information, or any other information, or combination of information, relevant to the transmitting vehicle state. For example, transmission state information may indicate whether the transmission of the transmitting vehicle is in a neutral state, a parked state, a forward state, or a reverse state.

The vehicle 210 may communicate with the communications network 230 via an access point 233. The access point 233, which may include a computing device, may be configured to communicate with a vehicle 210, with a communication network 230, with one or more communication devices 240, or with a combination thereof via wired or wireless communication links 231/234. For example, the access point 233 may be a base station, a base transceiver station (BTS), a Node-B, an enhanced Node-B (eNode-B), a Home Node-B (HNode-B), a central unit (CU), a distributed unit (DU), a radio unit (RU), an NR network node, a 6G network node, a transmission reception point (TRP), a mobility element of a network, a core network node, a network element, a network equipment, a wireless router, a wired router, a hub, a relay, a switch, or any similar wired or wireless device. Although shown as a single unit in FIG. 2, an access point may include any number of interconnected elements. An access point may be stationary or mobile.

The vehicle 210 may communicate with the communications network 230 via a satellite 235 or other non-terrestrial communication device. The satellite 235, which may include a computing device, may be configured to communicate with a vehicle 210, with a communication network 230, with one or more communication devices 240, or with a combination thereof via one or more communication links 232/236. Although shown as a single unit in FIG. 2, a satellite may include any number of interconnected elements.

An electronic communication network 230 may be any type of network configured to provide voice, data, or any other type of electronic communication. For example, the electronic communication network 230 may include a local area network (LAN), a wide area network (WAN), a virtual private network (VPN), a mobile or cellular telephone network, the Internet, an Internet of Things (IoT) network, or any other electronic communication system. The electronic communication network 230 may use a communication protocol, such as transmission control protocol (TCP), user datagram protocol (UDP), internet protocol (IP), real-time transport protocol (RTP), HyperText Transport Protocol (HTTP), or a combination thereof. Although shown as a single unit in FIG. 2, an electronic communication network may include any number of interconnected elements.

The vehicle 210 may identify a portion or condition of the vehicle transportation network 220. For example, the vehicle 210 may include one or more on-vehicle sensors, such as sensor 136 shown in FIG. 1, which may include a velocity sensor, a wheel velocity sensor, a camera, a gyroscope, an optical sensor, a laser sensor, a radar sensor, a sonic sensor, or any other sensor or device or combination thereof capable of determining or identifying a portion or condition of the vehicle transportation network 220. The sensor data may include lane line data, remote vehicle location data, or both.

The vehicle 210 may traverse a portion or portions of one or more vehicle transportation networks 220 using information communicated via the network 230, such as information representing the vehicle transportation network 220, information identified by one or more on-vehicle sensors, or a combination thereof.

Although for simplicity FIG. 2 shows two vehicles 210, 211, one vehicle transportation network 220, one electronic communication network 230, one communication device 240, one operations center 242, and one controller apparatus 244, any number of vehicles, networks, computing devices, communication networks, operations centers, and/or controller apparatuses may be used. The vehicle transportation and communication system 200 may include devices, units, or elements not shown in FIG. 2. Although the vehicle 210 is shown as a single unit, a vehicle may include any number of interconnected elements.

Although the vehicle 210 is shown communicating with the communication device 240 via the network 230, the vehicle 210 may communicate with the communication device 240 via any number of direct or indirect communication links. For example, the vehicle 210 may communicate with the communication device 240 via a direct communication link, such as a Bluetooth communication link.

In some embodiments, a vehicle 210/211 may be associated with an entity 250/260, such as a driver, operator, or owner of the vehicle. In some embodiments, an entity 250/260 associated with a vehicle 210/211 may be associated with one or more personal electronic devices 252/254/262/264, such as a smartphone 252/262 or a computer 254/264. In some embodiments, a personal electronic device 252/254/262/264 may communicate with a corresponding vehicle 210/211 via a direct or indirect communication link. Although one entity 250/260 is shown as associated with a respective vehicle 210/211 in FIG. 2, any number of vehicles may be associated with an entity and any number of entities may be associated with a vehicle.

The vehicle transportation network 220 shows only navigable areas (e.g., roads), but the vehicle transportation network may also include one or more unnavigable areas, such as a building, one or more partially navigable areas, such as a parking area or pedestrian walkway, or a combination thereof. The vehicle transportation network 220 may also include one or more interchanges between one or more navigable, or partially navigable, areas. A portion of the vehicle transportation network 220, such as a road, may include one or more lanes and may be associated with one or more directions of travel.

A vehicle transportation network 220, or a portion thereof, may be represented as vehicle transportation network data. For example, vehicle transportation network data may be expressed as a hierarchy of elements, such as markup language elements, which may be stored in a database or file. For simplicity, the figures herein depict vehicle transportation network data representing portions of a vehicle transportation network 220 as diagrams or maps; however, vehicle transportation network data may be expressed in any computer-usable form capable of representing a vehicle transportation network, or a portion thereof. The vehicle transportation network data may include vehicle transportation network control information, such as direction of travel information, speed limit information, toll information, grade information, such as inclination or angle information, surface material information, aesthetic information, defined hazard information, or a combination thereof.

A portion, or a combination of portions, of the vehicle transportation network 220 may be identified as a point of interest or a destination. For example, the vehicle transportation network data may identify a building as a point of interest or destination. The point of interest or destination may be identified using a discrete uniquely identifiable geolocation. For example, the vehicle transportation network 220 may include a defined location, such as a street address, a postal address, a vehicle transportation network address, a GPS address, or a combination thereof for the destination.

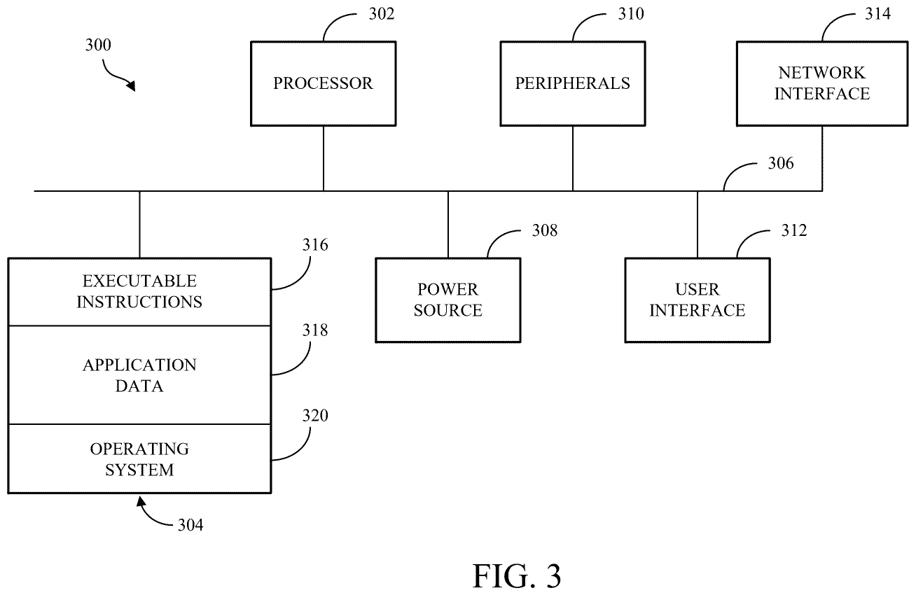

FIG. 3 shows a block diagram of an example of a computing device 300 capable of performing functions described herein. The computing device 300 may be, be similar to, include, or be included in, an apparatus for performing one or more methods, processes, algorithms, operations, tasks, and/or techniques, as described herein. The computing device 300 may be, be similar to, include, or be included in, an ICU, a VLA system, a fleet management device, a tele-operation device, a sensor, a communication device, a vehicle controller (e.g., the controller 130 shown in FIG. 1) and/or a vehicle computer, among other examples. The computing device 300 includes components or units, such as a processor 302, a memory 304, a bus 306, a power source 308, peripherals 310, a user interface 312, a network interface 314, other suitable components, or a combination thereof. One or more of the memory 304, the power source 308, the peripherals 310, the user interface 312, or the network interface 314 can communicate with the processor 302 via the bus 306.

The processor 302 may be any type of processing unit such as, for example, a central processing unit (CPU), a GPU, or a microprocessor, and may include single or multiple processors having single or multiple processing cores. The processor 302 can include another type of device, or multiple devices, configured for manipulating or processing information. For example, the processor 302 can include multiple processors interconnected in one or more manners, including hardwired or networked. The operations of the processor 302 can be distributed across multiple devices or units that can be coupled directly or across a local area or other suitable type of network. The processor 302 can include a cache, or cache memory, for local storage of operating data or instructions.

The memory 304 includes one or more memory components, which may each be volatile memory or non-volatile memory. For example, the volatile memory can be random access memory (RAM) (e.g., a DRAM module, such as DDR SDRAM). In another example, the non-volatile memory of the memory 304 can be a disk drive, a solid state drive, flash memory, or phase-change memory. In some implementations, the memory 304 can be distributed across multiple devices. For example, the memory 304 can include network-based memory or memory in multiple clients or servers performing the operations of those multiple devices.

The memory 304 can include data for immediate access by the processor 302. For example, the memory 304 can include executable instructions 316, application data 318, and an operating system 320. The executable instructions 316 can include one or more application programs, which can be loaded or copied, in whole or in part, from non-volatile memory to volatile memory to be executed by the processor 302. For example, the executable instructions 316 can include instructions for performing techniques of this disclosure. In some implementations, the application data 318 can include functional programs, such as a computational programs, analytical programs, database programs, and so on. The operating system 320 can be, for example, Microsoft Windows®, Mac OS X®, or Linux®; an operating system for a mobile device, such as a smartphone or tablet device; or an operating system for a non-mobile device, such as a mainframe computer.

The power source 308 provides power to the computing device 300. For example, the power source 308 can be an interface to an external power distribution system. In another example, the power source 308 can be a battery, such as where the computing device 300 is a mobile device or is otherwise configured to operate independently of an external power distribution system. In some implementations, the computing device 300 may include or otherwise use multiple power sources. In some such implementations, the power source 308 can be a backup battery. In some implementations, the power source 308 may include a power system of a vehicle. For example, the power source 308 may refer to a charging port installed in a vehicle, a charger configured to plug into the charging port, or a combination thereof.

The peripherals 310 may include one or more sensors, detectors, or other devices configured for monitoring the computing device 300 or the environment around the computing device 300. For example, the peripherals 310 can include a geolocation component, such as a GPS location unit. In another example, the peripherals can include a temperature sensor for measuring temperatures of components of the computing device 300, such as the processor 302. In some implementations, the computing device 300 can omit the peripherals 310.

The user interface 312 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 314 provides a connection or link to a network (e.g., the electronic communication network 230 shown in FIG. 2). The network interface 314 can be a wired network interface or a wireless network interface. The computing device 300 can communicate with other devices via the network interface 314 using one or more network protocols, such as using Ethernet, TCP, IP, power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof. For example, the computing device 300 can communicate with a database server.

The network interface 314 may include a transceiver, which may include a transmitter or a receiver. In some configurations, one or a combination of antenna(s), modem(s), multiple input multiple output (MIMO) detectors, receive processors, transmit processors, and/or the transmit MIMO processors may be included in the transceiver. The transceiver may be under control of or used by one or more processors, and in some aspects in conjunction with processor-readable code stored in the memory, to perform aspects of the methods, processes, techniques, and/or operations described herein.

In the description herein, sentences describing a vehicle, a system, or a device as taking an action (such as performing, determining, initiating, receiving, calculating, deciding, etc.) are to be understood that some appropriate component of the vehicle, system, or device as taking the action. Such components may refer to hardware and/or software configured to take the action.

An apparatus, computing device (e.g., the computing device 300), system, and/or vehicle, described herein may include one or more chips, system-on-chips (SoCs), chipsets, packages, and/or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include a memory system in the form of one or more memory devices, memory blocks, memory elements or other discrete gate or transistor logic or circuitry, each of which may include tangible storage media such as RAM or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The apparatus may include or may be included in a housing that houses components associated with the apparatus including the processing system.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 3, such as a single processor or a combination of multiple different processors. Reference to “one or more processors” should be understood to refer to any one or more of the processors described in connection with FIG. 3.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 3. For example, an operation described as being performed by one or more memories can be performed by the same subset of the one or more memories or different subsets of the one or more memories.

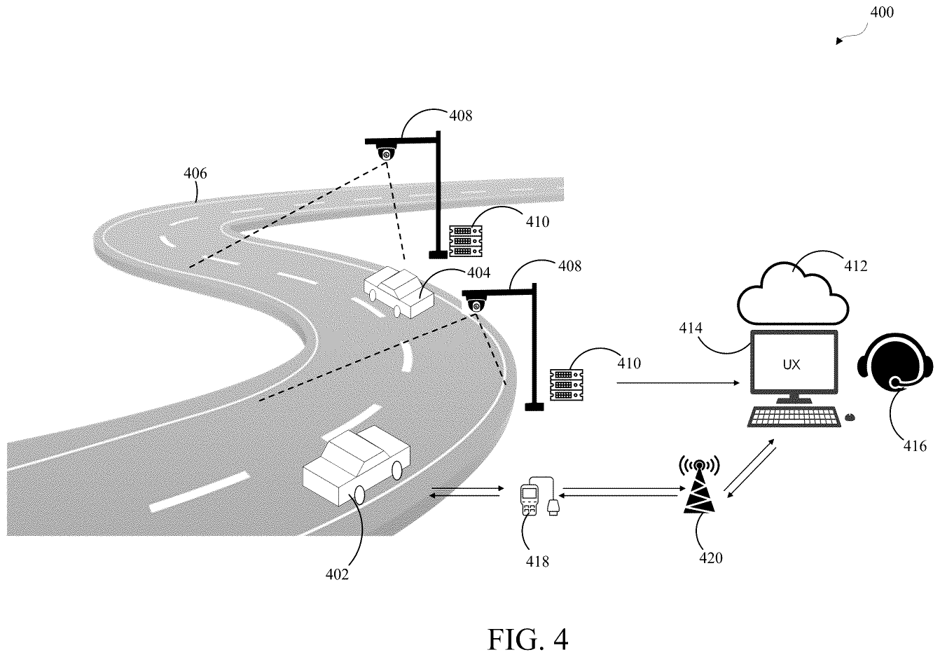

FIG. 4 is a schematic diagram showing an operating environment 400 within which aspects of the system and apparatuses described herein may be implemented. The operating environment 400 may be, be similar to, include, or be included in, a controlled roadway region where vehicles 402 and 404 are managed and transported autonomously. The operating environment 400 may be, be similar to, include, or be included in, the vehicle transportation and communication system 200 shown in FIG. 2.

The operating environment 400 includes a roadway 406. Along the roadway 406, multiple infrastructure components 408 are positioned. The infrastructure components 408 may include various sensors, cameras, and communication devices that continually monitor the environment and the vehicles 402 and 404. For example, the infrastructure components 408 may incorporate LiDAR sensors or radar systems to provide detailed environmental data.

The infrastructure components 408 may be implemented in various ways. In some implementations, the infrastructure components 408 may be affixed to and/or integrated into existing roadside equipment, such as street lights, traffic signals, or road signs. This approach may leverage pre-existing infrastructure, potentially reducing installation costs and minimizing additional visual clutter in the environment. For example, cameras or sensors may be fitted to street light poles, providing elevated vantage points for monitoring traffic flow and vehicle movements. In some implementations, the infrastructure components 408 may be standalone devices specifically designed for use with the VLA system. These purpose-built units may be optimized for the particular requirements of the controlled roadway region, potentially offering enhanced performance or specialized capabilities. In some implementations, a combination of retrofitted existing equipment and new standalone devices may be used to create a comprehensive sensor network that covers the controlled roadway region.

The data collected by the infrastructure components 408 is fed into a perception system 410. The perception system 410 may include hardware, software, or a combination of hardware and software configured to obtain raw data from the infrastructure components 408 and process the raw data to provide sensor data, sometimes referred to as “perception data.” The perception system 410 may use advanced algorithms to detect and track vehicles, identify potential obstacles, and monitor traffic flow within the controlled roadway region.

The operating environment 400 includes a VLA system 412. The VLA system 412 may be responsible for determining driving operations for controlling the vehicles. The VLA system 412 receives processed data from the perception system 410 and uses this information to generate driving instructions for each vehicle in the controlled roadway region.

The operating environment 400 may include a user interface 414 communicatively coupled to the VLA system 412. The user interface 414 may allow an operator 416 (e.g., a fleet operator) to monitor the entire system, view the status of individual vehicles, and intervene if necessary. In some implementations, the user interface 414 may serve as a tele-operation device enabling the operator 416 to provide additional instructions or take control of a vehicle in case of an operational issue.

Each vehicle 402 and 404 is equipped with an ICU 418. The ICUs 418 receive control signals from the VLA system 412 and execute the driving instructions, controlling the vehicles' movements within the operating environment 400.

Communication between the VLA system 412 and the ICUs 418 in the vehicles is facilitated by an access point 420. This access point 420 may use wireless technology to transmit control signals and receive status updates from the vehicles, ensuring constant connectivity throughout the controlled roadway region. The wireless technology may include, for example, cellular technology.

In some implementations, the operating environment 400 could be adapted to handle various scenarios within the controlled roadway region. For instance, the VLA system 412 may manage the movement of finished vehicles from a factory to a test course. The VLA system 412 could generate specific driving instructions for navigating the test course, while the infrastructure components 408 monitor the vehicle's performance during testing. In some implementations, the operating environment 400 may facilitate the efficient transfer of vehicles to the distribution hubs. The VLA system 412 could coordinate the movement of multiple vehicles simultaneously, optimizing routes to a railway distribution hub or a trucking distribution hub based on real-time conditions and scheduling requirements.

Any one or more of the infrastructure components 408, the perception system 410, the VLA system 412, the user interface 414, the access point 420, and/or the ICU 418, may be, be similar to, include, or be included in, the computing device 300 shown in FIG. 3. Similarly, the vehicle 402 and/or the vehicle 404 may be, be similar to, include, or be included in, the vehicle 100 shown in FIG. 1.

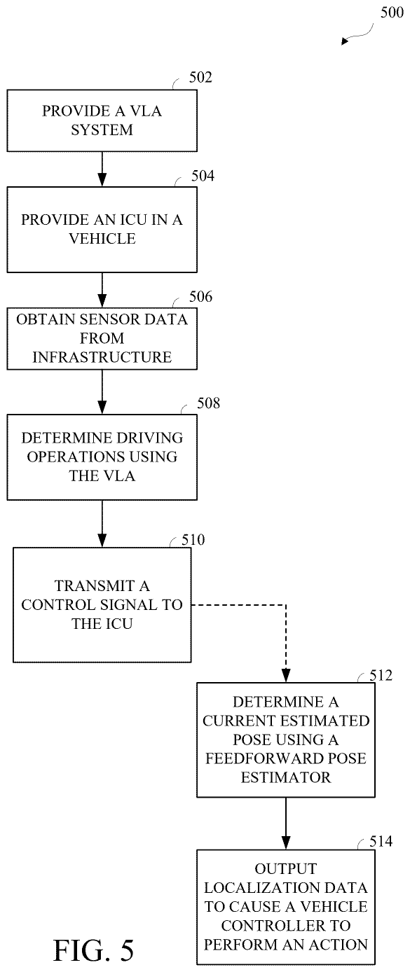

FIG. 5 is a flow diagram illustrating an example of a process 500 for controlling a vehicle in a controlled roadway region, in accordance with the present disclosure. The controlled roadway region may include any type of controlled roadway region such as, for example, the controlled roadway region of the operating environment 400 shown in FIG. 4.

At 502, a VLA system located outside of a vehicle is provided. This VLA system may be configured to determine driving operations for controlling the vehicle. In some aspects, the VLA system may be implemented as a cloud-based system, utilizing advanced computing resources to process data and generate control instructions. The VLA system may be designed to interface with various components of the controlled roadway region, such as the infrastructure components along the roadway.

At 504, an ICU for installation in the vehicle is provided. The ICU may include at least one sensor, which may be used to gather data about the vehicle's environment and operational status. In some implementations, the ICU may be designed to be easily installed and removed from various vehicle models, allowing for flexibility in the types of vehicles that can be controlled within the system. In some implementations, the ICU may be permanently installed in the vehicle. The VLA system and ICU may enable autonomous control throughout the controlled roadway region.

At 506, the VLA system obtains sensor data from an infrastructure. The infrastructure may include any number of different hardware and/or software components configured to gather data for use by the VLA system. For example, the infrastructure may include sensors such as, for example, radar, LIDAR, cameras, and/or any number of other types of sensors. In some implementations, the infrastructure may include one or more of the sensors that are typically installed in autonomous vehicles such as, for example, autonomous vehicles built for Level 4 (L4) (also referred to as “high driving automation” (HAD)) autonomous driving (AD) operations.

At 508, the VLA system generates driving instructions based on the sensor data. The driving instructions are intended for controlling the vehicle to traverse a transportation network of the controlled roadway region. In generating these instructions, the VLA system may take into account factors such as the current location of the vehicle, its destination, or traffic conditions within the controlled roadway region, among other examples.

At 510, the VLA system transmits a control signal to the ICU, where the control signal is indicative of the driving instructions generated in step 508. This transmission may occur wirelessly, utilizing communication infrastructure within the controlled roadway region. The communication infrastructure may include any number of different types of wireless communication networks such as, for example, a private cellular network (e.g., using an unlicensed 5G band), an IoT network, and/or a public cellular network, among other examples. The control signal may contain detailed instructions for the vehicle's movement, including speed, direction, and specific actions to be taken at various points along its route.

In some implementations, the driving instructions, when executed by a processor of the ICU, may be configured to cause the ICU to control the vehicle drive in the controlled roadway region. The VLA system used in this method may include cloud-based L4 AD software. This advanced software may enable the system to handle complex driving scenarios within the controlled roadway region without human intervention under normal circumstances. The L4 autonomy may allow the vehicles to navigate intersections and make decisions about routing and movement without constant human oversight.

To facilitate communication between the VLA system and the vehicle, the ICU may include a communication component configured to communicate with the VLA system. This communication component may utilize various wireless technologies to maintain a constant connection with the VLA system, ensuring that the vehicle can receive updated instructions and report its status in real-time as it moves through the controlled roadway region.

For integration with the vehicle's systems, the ICU may comprise a connection component configured to connect with a control area network (CAN) bus of the vehicle. This connection allows the ICU to interface directly with the vehicle's internal systems, enabling precise control over the vehicle's movements and functions. Through the CAN bus connection, the ICU may be able to control the vehicle's steering, acceleration, braking, and other functions to facilitate autonomous operation within the controlled roadway region.

In some aspects of the process 500, additional steps may be implemented to enhance the system's functionality. For instance, at 512, a feedforward pose estimator implemented on the vehicle may determine a current estimated pose and, at 514, the feedforward pose estimator may output localization data to cause a vehicle controller to perform an action. In some implementations, performing the action may include performing a steering action, performing an acceleration or deceleration action, or continuing to perform an action already being performed (e.g., maintaining a current speed, direction, etc.).

At 512, a feedforward pose estimator implemented on the vehicle determines a current estimated pose of the vehicle. The feedforward pose estimator obtains odometry data associated with the vehicle, such as the vehicle's speed and steering angle. It also obtains a first estimated pose of the vehicle based on a sensor measurement associated with a stationary sensor external to the vehicle, such as a LiDAR sensor. The sensor measurement may be indicative of a range between the vehicle and the stationary sensor.

The feedforward pose estimator then estimates a second estimated pose of the vehicle based on the odometry data and the first estimated pose. This estimation is performed by applying a feedforward estimation model to the odometry data and the first estimated pose. The feedforward estimation model may be based on an extended Kalman filter and may also incorporate a kinematic bicycle model.

To manage the input data, the system stores a first plurality of measurements including the first estimated pose of the vehicle in a first buffer, and stores a second plurality of measurements including the odometry data in a second buffer. These buffers may be implemented as linear buffers or ring buffers to efficiently manage the time-sequenced data.

The feedforward pose estimator processes the buffered data to generate the current estimated pose, which represents the vehicle's most up-to-date position and orientation. This approach may allow the system to compensate for delays in external sensor measurements and provide a more accurate and timely estimate of the vehicle's pose.

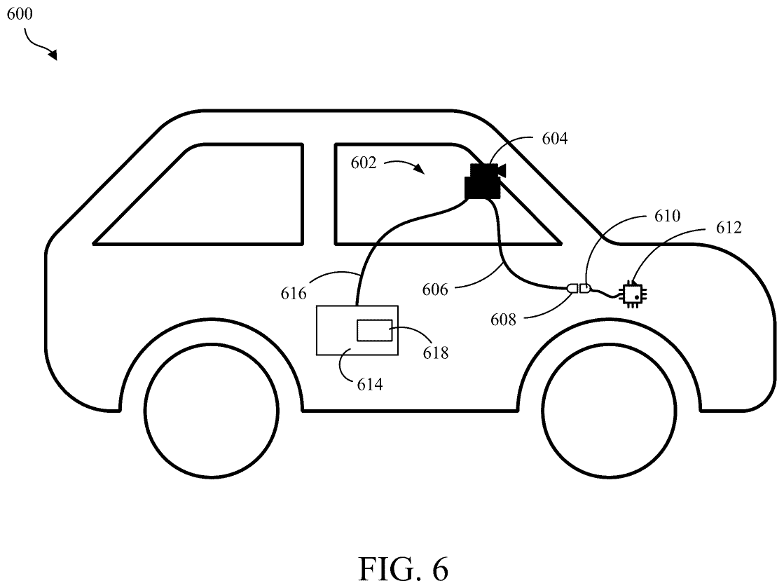

FIG. 6 is a diagram of an example of a vehicle 600 having an ICU 602 temporarily installed therein, in accordance with the present disclosure. The vehicle 600 may be, be similar to, include, or be included in, the vehicle 402 and/or the vehicle 404 shown in FIG. 4. The ICU 602 may be, be similar to, include, or be included in, the ICU 418 shown in FIG. 4.

In some implementations, the ICU 602 may be permanently installed in the vehicle 600. For example, the ICU 602 may be, be similar to, include, or be included in the controller 130 shown in FIG. 1. In some implementations, the ICU 602 may be temporarily installed in the vehicle 600. For example, the ICU 602 may be designed to be easily installed and removed, allowing for flexibility in equipping different vehicles with autonomous capabilities as they move through the controlled roadway region.

The ICU 602 may include a sensor assembly 604, which is shown mounted in a position that provides optimal access to the vehicle's systems and clear line of sight for any integrated sensors. This placement may be on the dashboard or windshield area, ensuring that the unit does not interfere with the vehicle's standard operations or safety features. The sensor assembly 604 may include a camera, serving as a sensor for the autonomous system and/or for tele-operations. The camera may be positioned to capture the view in front of the vehicle 600, providing visual data that the VLA system can use for navigation, obstacle detection, and environmental awareness. The ICU 602 is connected to the vehicle's systems (e.g., the CAN) via a connection cable 606 which serves as the primary interface between the ICU 602 and the vehicle's internal network, allowing for the exchange of data and control signals. The connection cable 606 may be designed to be robust and secure, ensuring reliable communication between the ICU 602 and the vehicle 600 even in challenging environmental conditions or during complex maneuvers.

At one end of the connection cable 606 is an ICU connector 608. This connector is specifically designed to interface with the ICU 602, providing a secure and efficient connection point. The ICU connector 608 may include multiple pins or interfaces to accommodate various types of data transmission and power supply to the ICU 602 via a CAN connector 610 coupled to the CAN 612 of the vehicle 600. The CAN 612 includes a standard protocol used in most modern vehicles for internal communications between different electronic control units. By connecting to the CAN 612, the ICU 602 gains access to a wide range of vehicle data and control systems, allowing it to monitor the vehicle's status and issue commands for steering, acceleration, braking, and other functions that may facilitate autonomous operation. The ICU 602 may act as the on-board agent of the VLA system, executing the driving instructions received from the VLA system and providing real-time feedback about the vehicle's status and surroundings.

The ICU 602 may include an electronics component 614 that may serve as a processing unit and/or an interface module for the ICU 602. In some implementations, the electronics component 614 may include a microprocessor, memory, and various input/output interfaces to facilitate the operations of the ICU 602. The electronics component 614 may be connected to the sensor assembly 604 via a connection cable 616, which may allow for high-speed data transfer between the two components. In some cases, the electronics component 614 may include specialized hardware for specific tasks such as image processing, sensor fusion, or real-time decision making. For example, the electronics component 614 may include a feedforward estimator 618, as described herein.

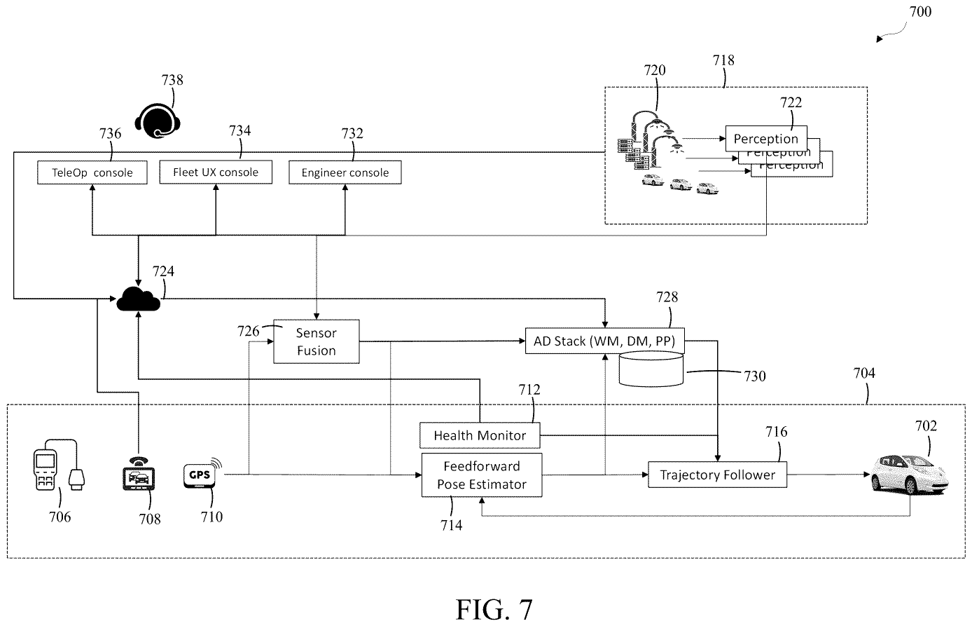

FIG. 7 is a diagram illustrating an example 700 associated with controlling a vehicle in a controlled roadway region, in accordance with the present disclosure. The example 700 includes a vehicle 702, which may be, be similar to, include, or be included in, the vehicle 402 and/or the vehicle 404 shown in FIG. 4. The vehicle 702 is equipped with a vehicle network 704, which may include various onboard systems and sensors. An ICU 706 is installed in the vehicle 702, as described in the process 500 of FIG. 5. The ICU 706 may be, be similar to, include, or be included in, the ICU 602 shown in FIG. 6 and may serve as the primary interface between the vehicle 600 and the external control systems.

The ICU 706 includes several components that enable its autonomous control capabilities. A camera 708 may be provided to capture visual data of the vehicle's surroundings. A GPS 710 may be included for precise location tracking. A health monitor 712 continually assesses the status of the vehicle's systems, ensuring safe operation. A feedforward pose estimator 714 estimates a current pose of the vehicle. In some implementations, the feedforward pose estimator 714 may predict the vehicle's future position and orientation, while a trajectory follower 716 executes the planned path for the vehicle 702.

In some implementations, the health monitor 712 may continually assess various vehicle systems and parameters, including but not limited to engine performance, battery status, tire pressure, brake function, steering responsiveness, communication latency, communication status, lane deviation, localization source consistency, localization updates, tele-operator over-rides, and/or clock synchronization. In some implementations, the health monitor 712 may employ a finite state machine (FSM) to coordinate vehicle control between a tele-operator, the vehicle, and an occasional human driver. In some implementations, the health monitor 712 may set a speed limit or initiate stopping of the vehicle in response to detecting an issue. This real-time monitoring may allow for early detection of potential issues that could affect the vehicle's ability to operate autonomously or compromise safety.

In cases where the health monitor 712 detects an anomaly or a deviation from expected operational parameters, it may trigger an alert within the VLA system. The VLA system may then evaluate the severity and nature of the issue to determine the appropriate course of action. In some instances, minor issues may be addressed through automated adjustments or by rerouting the vehicle to a maintenance area. However, for more complex or critical issues, the health monitor's alert may prompt the VLA system to initiate a request for teleoperation.

When a teleoperation request is triggered, the system may transmit detailed diagnostic information from the health monitor to the remote operator interface. This may include specific error codes, sensor readings, and performance metrics that can help the human operator quickly assess the situation. The teleoperation interface may present this information in an easily digestible format, potentially using visual aids or augmented reality overlays to highlight the affected vehicle systems. Based on this comprehensive health data, the remote operator may make informed decisions about how to safely manage the vehicle, whether by providing specific control inputs, guiding the vehicle to a designated area for inspection, or coordinating with on-site maintenance teams for immediate intervention.

The example 700 also includes infrastructure 718, which may be, be similar to, include, or be included in, the infrastructure components 408 shown in FIG. 4. The infrastructure 718 comprises various infrastructure components 720 that generate perception data 722 about the controlled roadway region. This data may include information about road conditions, other vehicles, and potential obstacles.

The perception data 722 is transmitted to a cloud environment 724, which hosts the core processing and decision-making components of the system. Within the cloud 724, a sensor fusion component 726 integrates data from multiple sources, including the infrastructure 718 and the ICU 706. This fused data is then processed by an automated driving (AD) system 728 (shown as an “AD stack”), which may be, be similar to, include, or be included in, the VLA system described herein. The AD system 728 includes several modules that work together to control the vehicle 702. These modules may include a world model (WM) that maintains a comprehensive representation of the environment, a decision making (DM) component that determines the best course of action, and a path planning (PP) module that generates optimal routes for the vehicle.

A database 730 is connected to the AD system 728, storing historical data, map information, and other relevant data that may be used by the AD system 728 to improve its decision-making capabilities. This database 730 may be continually updated with new information gathered from the vehicles and infrastructure.

The example 700 also includes several user interfaces that allow human operators to monitor and control the vehicle 702. An engineer console 732 may provide access to detailed system diagnostics and configuration options. A fleet UX console 734 may offer a high-level view of all vehicles operating within the controlled roadway region, allowing for efficient management of multiple vehicles simultaneously. A tele-operation console 736 may enable direct control of individual vehicles when necessary. One or more operators 738 may interact with one or more consoles 732, 734, or 736 to oversee the system's operation. The operator 738 may intervene in case of any issues or special circumstances that require human judgment.

The cloud environment 724 may include edge computing nodes located near the controlled roadway region, reducing latency and improving real-time responsiveness. These edge nodes could perform initial processing of perception data 722 before sending it to the central cloud system for higher-level decision making. In some implementations, the example 700 may incorporate V2V communication capabilities, allowing vehicles to share information directly with each other. This could enhance collision avoidance and traffic flow optimization within the controlled roadway region. The example 700 may also include interfaces with external logistics systems, enabling seamless integration with broader supply chain management processes. This could allow for dynamic routing and scheduling based on real-time demand and distribution requirements.

Some implementations of the architecture include a multi-layered approach to data flow, utilizing various communication protocols and technologies to ensure robust, real-time information exchange between different components. In some implementations, a message queuing telemetry transport (MQTT) server may be utilized within the cloud environment 724 to handle the high-volume, low-latency messaging required for real-time vehicle control. MQTT servers act as message brokers, facilitating publish-subscribe communication patterns between different components of the system. For instance, the infrastructure components 720 may publish perception data 722 to specific MQTT topics, which the sensor fusion component 726 subscribes to, ensuring efficient and timely delivery of critical environmental information.

The communication between the cloud environment 724 and the vehicle 702 may utilize a combination of cellular networks and DSRC. Cellular networks, such as 4G LTE or 5G, may provide long-range connectivity, allowing the AD system 728 to send high-level control commands and receive status updates from the ICU 706. DSRC, on the other hand, may be used for vehicle-to-infrastructure (V2I) communication, enabling low-latency exchange of safety information between the vehicle and nearby infrastructure components.

Within the vehicle 702, the vehicle network 704 may employ CAN bus communication, similar to the CAN 612 described in FIG. 6. This allows the ICU 706 to interface with various vehicle subsystems, receiving sensor data and sending control commands. The ICU 706 may act as a gateway, translating between the CAN protocol used internally and the external communication protocols used to interact with the cloud environment 724.

The cloud environment 724 may utilize a combination of REST (Representational State Transfer) APIs and WebSocket protocols for communication between its internal components and external interfaces. REST APIs may be used for non-real-time operations, such as updating the database 730 or retrieving configuration information. WebSocket protocols may be employed for real-time bidirectional communication, particularly for the user interfaces like the engineer console 732, fleet UX console 734, and tele-operation console 736, allowing for live updates and immediate operator interventions.

To handle the large volumes of data generated by the infrastructure 718 and multiple vehicles, the system may employ data streaming technologies. This allows for scalable, fault-tolerant distribution of data streams across the various components of the AD system 728. For example, the WM module may consume streams of fused sensor data to maintain an up-to-date representation of the environment, while simultaneously publishing updates that the DM and PP modules can consume.

The communication architecture also may incorporate redundancy and failover mechanisms to ensure system reliability. For instance, if the primary communication channel between the cloud environment 724 and a vehicle fails, the system may switch to a backup cellular network or even a satellite communication link. Additionally, edge computing nodes near the controlled roadway region may cache data and provide basic control functionality in case of temporary disconnection from the central cloud system.

The trajectory follower 716, feedforward pose estimator 714, and sensor fusion component 726 may work together to determine and maintain accurate vehicle pose and control within the controlled roadway region. The feedforward pose estimator 714, located within the ICU 706, may use data from a location device (such as, for example, the GPS 710, a GNSS device, a WAAS NMEA unit, a real-time kinematic (RTK) device, or a combination thereof) and other on-board sensors to estimate a current pose of the vehicle 702 and/or to predict the vehicle's future position and orientation. The feedforward pose estimator 714 may employ algorithms that take into account the vehicle's current state, including its velocity, acceleration, and steering angle, to estimate the current pose of the vehicle 702 and/or where the vehicle 702 will be in the near future.

The sensor fusion component 726, located in the cloud environment 724, may integrate data from multiple sources to create a comprehensive understanding of the vehicle's environment and its position within it. This component may combine perception data 722 from the infrastructure components 720 with data from the vehicle's on-board sensors, including the camera 708 and GPS 710. By fusing these diverse data streams, the sensor fusion component 726 can create a more accurate and robust representation of the vehicle's pose and its surroundings than would be possible with any single sensor. This fused data may then be used by the AD system 728 to make informed decisions about vehicle control.

The trajectory follower 716, also part of the ICU 706, may use the pose estimates from the feedforward pose estimator 714 and the fused sensor data from the cloud environment 724 to execute the planned path for the vehicle. This component may continuously compare the vehicle's current and predicted positions with the desired trajectory generated by the PP module of the AD system 728. Based on this comparison, the trajectory follower 716 may generate control commands to adjust the vehicle's steering, acceleration, and braking to maintain the desired path. The trajectory follower 716 may also adapt to real-time changes in the environment or unexpected deviations from the planned path, ensuring that the vehicle remains on course and avoids obstacles.

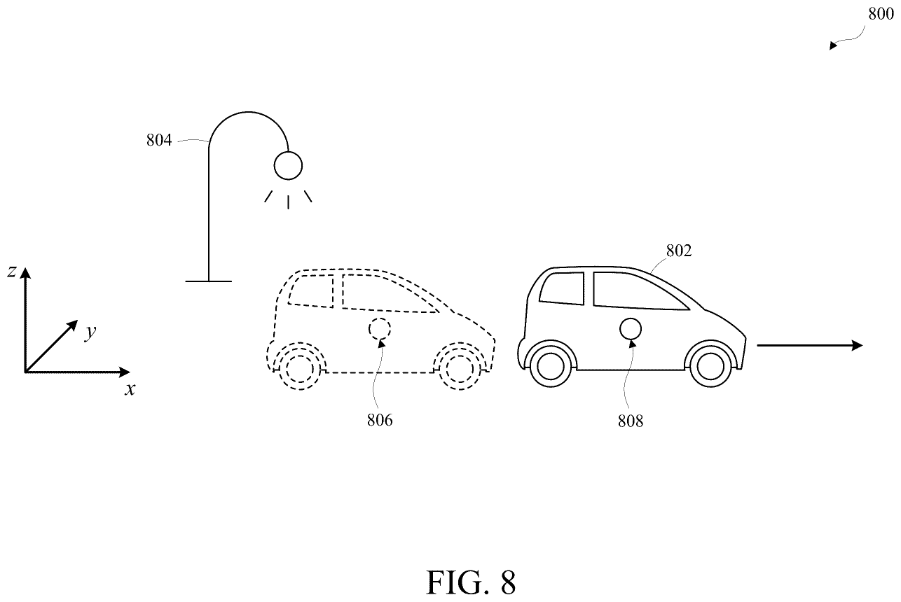

FIG. 8 is a diagram illustrating an example 800 associated with feedforward localization, in accordance with the present disclosure. The example 800 includes a vehicle 802 that can move between different positions, and an infrastructure sensor 804 mounted in a fixed location for detecting the vehicle's position. The infrastructure sensor 804 is shown monitoring the vehicle 802 as it moves from a prior position 806 (shown in dashed lines) to a current position 808 (shown in solid lines). The diagram depicts how the infrastructure sensor 804 tracks the movement of the vehicle 802 along a path, with the coordinate axes shown indicating the spatial reference frame used for localization.

In some implementations, the infrastructure sensor 804 may be a LiDAR sensor. The LiDAR sensor may be configured to provide measurements indicative of a range between the vehicle 802 and the infrastructure sensor 804. These measurements may be used to obtain a first estimated pose of the vehicle 802 based on sensor measurements associated with the stationary sensor external to the vehicle.

The example 800 illustrates the challenge addressed by the feedforward localization system disclosed herein. As the vehicle 802 moves from the prior position 806 to the current position 808, there is a delay between when the infrastructure sensor 804 detects the vehicle's position and when that information is processed and made available for use in vehicle control. During this delay, the vehicle 802 continues to move, potentially introducing errors in the vehicle's estimated position if only the delayed sensor measurements are used.

To address this challenge, the feedforward localization system may utilize odometry data associated with the vehicle 802. This odometry data may be indicative of one or more of a speed of the vehicle or a steering angle of the vehicle. By combining this real-time odometry data with the delayed sensor measurements from the infrastructure sensor 804, the system can provide a more accurate estimate of the vehicle's current position.

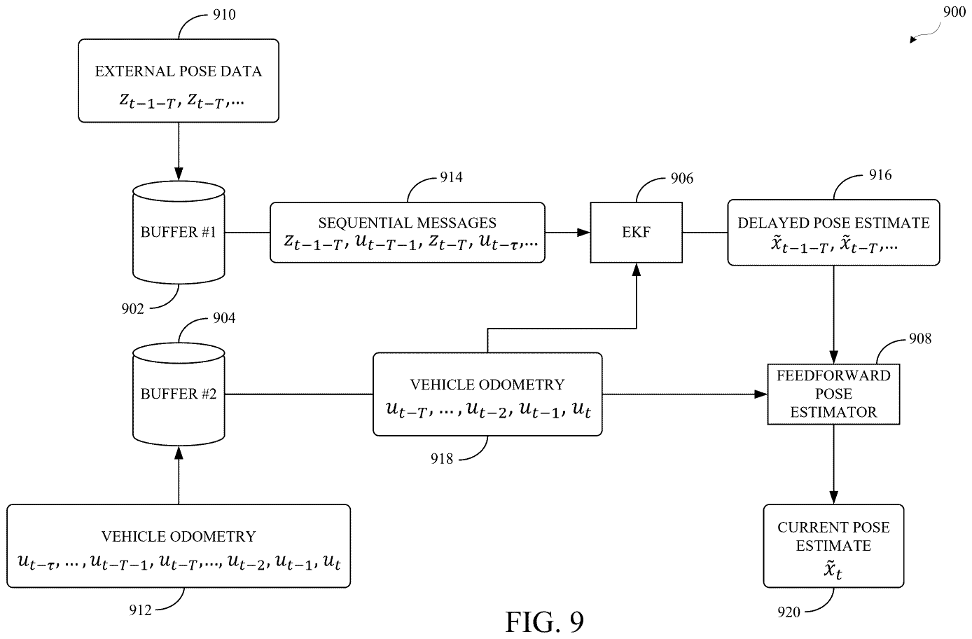

FIG. 9 is a schematic block diagram illustrating an example of a process 900 for feedforward localization, in accordance with the present disclosure. The process may be performed by a system including a feedforward pose estimator such as, for example, the feedforward pose estimator 714 shown in FIG. 7 or the feedforward pose estimator 618 shown in FIG. 6. The system includes a first buffer 902 and a second buffer 904 that receive and store different types of input data, an EKF component 906, and the feedforward pose estimator 908. In some implementations, the first buffer 902 and the second buffer 904 may comprise at least one of a linear buffer or a ring buffer. The use of these buffers allows the system to store and manage a sequence of measurements over time, which may be useful for the feedforward estimation process. The use of ring buffers may allow the system to efficiently manage and process time-sequenced data, ensuring that the most relevant historical information is used in the pose estimation process while automatically discarding outdated measurements.

The first buffer 902 receives external pose data 910, which is pose data obtained from an infrastructure sensor such as a LiDAR (e.g., the infrastructure sensor 804 shown in FIG. 8). The external pose data may be represented as:

$$\{ {z}_{t - τ} , … , {z}_{t - T - 1} , {z}_{t - T} \} ,$$

where Z_{t-T} represents a position measurement of a vehicle at a time instance that is T time units prior to a current time t. The time units may be seconds or milliseconds, among other examples. The external pose data 910 may include, for example, a first estimated pose.

In some implementations, as shown in FIG. 9, the second buffer 904 receives vehicle odometry data 912. A data point of the vehicle odometry data 912 may be represented as, for a current time t, uₜ, where uₜ includes a steering angle measurement and a speed measurement. The vehicle odometry data 912 may be represented as:

$$\{ {u}_{t - τ} , {u}_{t - T} , … , {u}_{t - 2} , {u}_{t - 1} , {u}_{t} \} .$$

The system processes sequential messages 914 through an EKF 906, which generates a delayed pose estimate 916, which is provided to the feedforward pose estimator 908. The EKF 906 may be part of a feedforward estimation model used to estimate the vehicle's pose. In some implementations, the EKF 906 may include a KBM, which provides a simplified representation of the vehicle's motion dynamics. For example, as shown, the sequential messages 914 may be a set of temporally sequential messages including an external pose data portion and a vehicle odometry data portion, from the first buffer 902 and the second buffer 904, respectively:

$$\{ {z}_{t - T - 1} , {u}_{t - T - 1} , {z}_{t - T} , {u}_{t - τ} , … \} ,$$

which may be used by the EKF 906 to generate a delayed pose estimate:

$${\tilde{x}}_{t - T - 1} , {\tilde{x}}_{t - T} , … ,$$

which represents the latest pose up to the last external pose data update. The vehicle odometry data portion 918 also may be provided to the feedforward pose estimator 908. The feedforward pose estimator 908 processes the delayed pose estimate 916 with the vehicle odometry data portion 918 to generate a current pose estimate 920, \tilde{x}ₜ. This current pose estimate 920 represents the second estimated pose of the vehicle, which is determined based on the odometry data and the first estimated pose of the vehicle. In some implementations, the feedforward pose estimator 908 may determine the current pose estimate 920 by iterating the EKF process model of form:

$${\tilde{x}}_{t + 1} = f ( {\tilde{x}}_{t} , {u}_{t} ) .$$

The process 900 illustrates how the feedforward localization system integrates delayed external measurements with more recent on-board odometry data. This approach allows for more accurate and up-to-date vehicle localization, even in the presence of communication delays between external sensors and the vehicle.

In some implementations, the system may employ additional techniques to enhance the accuracy and robustness of the pose estimation process. For example, the system may incorporate adaptive error covariance estimation to account for varying levels of uncertainty in different sensor measurements. This could involve dynamically adjusting the weights given to odometry data and external measurements based on their estimated reliability.

The system may also implement outlier rejection mechanisms to identify and discard erroneous measurements that could otherwise degrade the accuracy of the pose estimates. This could involve statistical tests to detect measurements that deviate significantly from expected values, based on the vehicle's predicted motion and historical data.

In some implementations, the feedforward localization system may be integrated with other vehicle control systems to provide a comprehensive solution for autonomous vehicle operation. For example, the current pose estimate 920 generated by the feedforward pose estimator 908 may be used as input to a trajectory planning system, which could generate optimal paths for the vehicle based on its estimated position and the surrounding environment.

The system may also be designed to handle various edge cases and failure scenarios. For instance, if external sensor measurements become temporarily unavailable, the system may rely more heavily on odometry data for short periods, while also increasing the uncertainty associated with its pose estimates. Conversely, if odometry data becomes unreliable (e.g., due to wheel slippage), the system may place greater weight on external measurements and potentially reduce the vehicle's speed to maintain localization accuracy.

By combining delayed external measurements with real-time on-board odometry data, the feedforward localization system disclosed herein may provide a robust solution for vehicle localization in environments with significant sensor and communication latencies. This approach may enable reliable autonomous vehicle control in complex scenarios, such as finished vehicle logistics operations in controlled roadway environments.

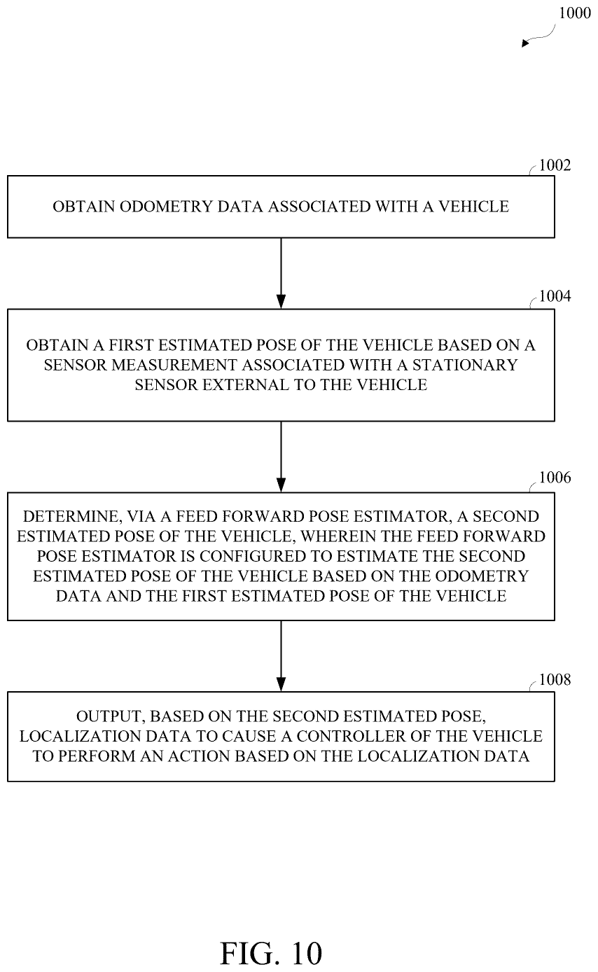

To further describe some implementations in greater detail, reference is next made to examples of techniques which may be performed by or using the vehicle localization system as described herein. FIG. 10 is a flowchart of an example of a technique associated with feedforward localization. The technique 1000 can be executed using computing devices, such as the systems, hardware, and software described with respect to FIGS. 1-9. The technique 1000 can be performed, for example, by executing a machine-readable program or other computer-executable instructions, such as routines, instructions, programs, or other code. The steps, or operations, of the technique 1000, or another technique, method, process, or algorithm described in connection with the implementations disclosed herein can be implemented directly in hardware, firmware, software executed by hardware, circuitry, or a combination thereof.

For simplicity of explanation, the technique 1000 is depicted and described herein as a series of steps or operations. However, the steps or operations of the technique 1000 can occur in various orders and/or concurrently. Additionally, other steps or operations not presented and described herein may be used. Furthermore, not all illustrated steps or operations may be required to implement a technique in accordance with the disclosed subject matter.

At 1002, the technique 1000 includes obtaining odometry data associated with a vehicle. For example, a feedforward pose estimator (e.g., the feedforward pose estimator 714 shown in FIG. 7) may obtain odometry data from sensors within the vehicle. In some implementations, the odometry data may be indicative of one or more of a speed of the vehicle or a steering angle of the vehicle. The odometry data may be obtained from various sources, such as wheel encoders, inertial measurement units (IMUs), or steering angle sensors. In some implementations, the odometry data may also include data from visual odometry systems that estimate movement based on camera images.

At 1004, the technique 1000 includes obtaining a first estimated pose of the vehicle based on a sensor measurement associated with a stationary sensor external to the vehicle. For example, a sensor fusion component (e.g., the sensor fusion component 726 shown in FIG. 7) may receive data from infrastructure components (e.g., the infrastructure components 720 shown in FIG. 7) to obtain the first estimated pose. In some implementations, the stationary sensor may comprise a LiDAR sensor. The sensor measurement may be indicative of a range between the vehicle and the stationary sensor. In some implementations, multiple stationary sensors may be used to triangulate the vehicle's position, potentially improving the accuracy of the first estimated pose.

At 1006, the technique 1000 includes determining, via a feedforward pose estimator, a second estimated pose of the vehicle. The feedforward pose estimator may be configured to estimate the second estimated pose of the vehicle based on the odometry data and the first estimated pose of the vehicle. For example, the feedforward pose estimator 714 shown in FIG. 7 may perform this determination. In some implementations, the feedforward pose estimator may apply a feedforward estimation model to the odometry data and the first estimated pose of the vehicle. The feedforward estimation model may be based on an EKF. In some implementations, the feedforward estimation model may be further based on a kinematic bicycle model, which provides a simplified representation of the vehicle's motion dynamics.

The process of determining the second estimated pose may involve several steps. First, the feedforward pose estimator may use the odometry data to predict how the vehicle's pose has changed since the last update. Then, it may compare this prediction with the first estimated pose obtained from the external sensors. By combining these two sources of information, the feedforward pose estimator can generate a more accurate estimate of the vehicle's current pose. This approach allows the system to compensate for delays in receiving external sensor data and to provide continuous pose estimates even when external measurements are temporarily unavailable.

In some implementations, the technique 1000 may include storing the input data in buffers before processing. For example, a first buffer may store a first plurality of measurements including the first estimated pose of the vehicle, while a second buffer may store a second plurality of measurements including the odometry data. These buffers may comprise at least one of a linear buffer or a ring buffer. The use of buffers allows the system to manage and process time-sequenced data efficiently, ensuring that the most relevant historical information is used in the pose estimation process while automatically discarding outdated measurements.

At 1008, the technique 1000 includes outputting, based on the second estimated pose, localization data to cause a controller of the vehicle to perform an action based on the localization data. For example, the feedforward pose estimator 714 may output the localization data to the trajectory follower 716 shown in FIG. 7. The action performed by the vehicle controller may include adjusting the vehicle's steering, acceleration, or braking to maintain a desired trajectory. In some implementations, the action may involve updating a display to show the vehicle's current position on a map.

In some implementations, the technique 1000 may include additional steps to enhance the accuracy and robustness of the pose estimation process. For example, the system may implement outlier rejection mechanisms to identify and discard erroneous measurements that could otherwise degrade the accuracy of the pose estimates. This could involve statistical tests to detect measurements that deviate significantly from expected values, based on the vehicle's predicted motion and historical data.

The technique 1000 may also incorporate adaptive error covariance estimation to account for varying levels of uncertainty in different sensor measurements. This could involve dynamically adjusting the weights given to odometry data and external measurements based on their estimated reliability. For instance, if the system detects that the vehicle is traveling on a slippery surface, it may reduce the weight given to wheel odometry data and rely more heavily on external sensor measurements.

In some implementations, the technique 1000 may be integrated with other vehicle control systems to provide a comprehensive solution for autonomous vehicle operation. For example, the localization data generated by the feedforward pose estimator may be used as input to a trajectory planning system, which could generate optimal paths for the vehicle based on its estimated position and the surrounding environment. This integration could enable more efficient and safer autonomous vehicle operations, particularly in complex environments such as controlled roadway regions.

The technique 1000 may also be designed to handle various edge cases and failure scenarios. For instance, if external sensor measurements become temporarily unavailable, the system may rely more heavily on odometry data for short periods, while also increasing the uncertainty associated with its pose estimates. Conversely, if odometry data becomes unreliable (e.g., due to wheel slippage), the system may place greater weight on external measurements and potentially reduce the vehicle's speed to maintain localization accuracy. These adaptive strategies help ensure robust performance across a wide range of operating conditions.

The foregoing disclosure provides illustration and description but is not intended to be exhaustive or to limit the aspects to the precise forms disclosed. Modifications and variations may be made in light of the above disclosure or may be acquired from practice of the aspects. As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, the terminology “instructions” may include directions or expressions for performing any technique, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, techniques, or combinations thereof, as described herein. Instructions, or a portion thereof, may be implemented as a special purpose processor, or circuitry, that may include specialized hardware for carrying out any of the techniques, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the terminology “example”, “embodiment”, “implementation”, “aspect”, “feature”, or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify”, or any variations thereof, includes selecting, ascertaining, computing, looking up, receiving, determining, establishing, obtaining, or otherwise identifying or determining in any manner whatsoever using one or more of the devices shown and described herein. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the terminology “or” is intended to mean an inclusive “or” rather than an exclusive “or” and may be used interchangeably with “and/or,” unless explicitly stated otherwise (for example, if used in combination with “either” or “only one of”), or clearly is used otherwise from context. In addition, the articles “a” and “an” as used in this application and the appended claims should generally be construed to mean “one or more” unless specified otherwise or clear from context to be directed to a singular form. Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Accordingly, unless explicitly stated otherwise, the phrase “based on” is intended to mean “based at least in part on.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. Further, for simplicity of explanation, although the figures and descriptions herein may include sequences or series of steps or stages, elements of the techniques disclosed herein may occur in various orders or concurrently. Additionally, elements of the techniques disclosed herein may occur with other elements not explicitly presented and described herein. Furthermore, not all elements of the techniques described herein may be required to implement a technique in accordance with this disclosure. Although aspects, features, and elements are described herein in particular combinations, each aspect, feature, or element may be used independently or in various combinations with or without other aspects, features, and elements.

The above-described aspects, examples, and implementations have been described in order to allow easy understanding of the disclosure are not limiting. On the contrary, the disclosure covers various modifications and equivalent arrangements included within the scope of the appended claims, which scope is to be accorded the broadest interpretation so as to encompass all such modifications and equivalent structure as is permitted under the law.

What is claimed is:

1. A system for vehicle localization, comprising:
one or more memories storing computer-executable instructions; and
processing circuitry communicatively coupled to the one or more memories, the processing circuitry configured to execute the computer-executable instructions to cause the system to:
obtain odometry data associated with a vehicle;
obtain a first estimated pose of the vehicle based on a sensor measurement associated with a stationary sensor external to the vehicle;
determine, via a feedforward pose estimator, a second estimated pose of the vehicle, wherein the feedforward pose estimator is configured to estimate the second estimated pose of the vehicle based on the odometry data and the first estimated pose of the vehicle; and
output, based on the second estimated pose, localization data to cause a controller of the vehicle to perform an action based on the localization data.

2. The system of claim 1, wherein the odometry data is indicative of one or more of a speed of the vehicle or a steering angle of the vehicle.

3. The system of claim 1, wherein the sensor measurement is indicative of a range between the vehicle and the stationary sensor.

4. The system of claim 1, wherein the stationary sensor comprises a light detection and ranging (LiDAR) sensor.

5. The system of claim 1, wherein the feedforward pose estimator is configured to estimate the second estimated pose of the vehicle based on the odometry data and the first estimated pose of the vehicle by applying a feedforward estimation model to the odometry data and the first estimated pose of the vehicle, and wherein the feedforward estimation model is based on an extended Kalman filter.

6. The system of claim 5, wherein the feedforward estimation model is further based on a kinematic bicycle model.

7. The system of claim 1, wherein the processing circuitry is configured to execute the computer-executable instructions to further cause the system to:
store, in a first buffer, a first plurality of measurements including the first estimated pose of the vehicle, and
store, in a second buffer, a second plurality of measurements including the odometry data.

8. The system of claim 7, wherein the first buffer and the second buffer comprise at least one of a linear buffer or a ring buffer.

9. A method for vehicle localization, comprising:
obtaining odometry data associated with a vehicle;
obtaining a first estimated pose of the vehicle based on a sensor measurement associated with a stationary sensor external to the vehicle;
determining, via a feedforward pose estimator, a second estimated pose of the vehicle, wherein the feedforward pose estimator is configured to estimate the second estimated pose of the vehicle based on the odometry data and the first estimated pose of the vehicle; and
outputting, based on the second estimated pose, localization data to cause a controller of the vehicle to perform an action based on the localization data.

10. The method of claim 9, wherein the odometry data is indicative of one or more of a speed of the vehicle or a steering angle of the vehicle.

11. The method of claim 9, wherein the feedforward pose estimator is configured to estimate the second estimated pose of the vehicle based on the odometry data and the first estimated pose of the vehicle by applying a feedforward estimation model to the odometry data and the first estimated pose of the vehicle, and wherein the feedforward estimation model is based on an extended Kalman filter.

12. The method of claim 11, wherein the feedforward estimation model is further based on a kinematic bicycle model.

13. The method of claim 9, further comprising:
storing, in a first buffer, a first plurality of measurements including the first estimated pose of the vehicle, and
storing, in a second buffer, a second plurality of measurements including the odometry data.

14. The method of claim 13, wherein the first buffer and the second buffer comprise at least one of a linear buffer or a ring buffer.

15. A non-transitory computer-readable storage medium storing a set of instructions that, when executed by processing circuitry of a controller of a vehicle, cause the controller to perform operations comprising:
obtaining odometry data associated with a vehicle;
obtaining a first estimated pose of the vehicle based on a sensor measurement associated with a stationary sensor external to the vehicle;
determining, via a feedforward pose estimator, a second estimated pose of the vehicle, wherein the feedforward pose estimator is configured to estimate the second estimated pose of the vehicle based on the odometry data and the first estimated pose of the vehicle; and
outputting, based on the second estimated pose, localization data to cause a controller of the vehicle to perform an action based on the localization data.

16. The non-transitory computer-readable storage medium of claim 15, wherein the stationary sensor comprises a light detection and ranging (LiDAR) sensor.

17. The non-transitory computer-readable storage medium of claim 15, wherein the feedforward pose estimator is configured to estimate the second estimated pose of the vehicle based on the odometry data and the first estimated pose of the vehicle by applying a feedforward estimation model to the odometry data and the first estimated pose of the vehicle, and wherein the feedforward estimation model is based on an extended Kalman filter.

18. The non-transitory computer-readable storage medium of claim 17, wherein the feedforward estimation model is further based on a kinematic bicycle model.

19. The non-transitory computer-readable storage medium of claim 15, wherein the operations further comprise:
storing, in a first buffer, a first plurality of measurements including the first estimated pose of the vehicle, and
storing, in a second buffer, a second plurality of measurements including the odometry data.

20. The non-transitory computer-readable storage medium of claim 19, wherein the first buffer and the second buffer comprise at least one of a linear buffer or a ring buffer.
